(19) United States
(12) Patent Application Publication
(10) Pub. No.: US 2012/0313823 A1
(43) Pub. Date: Dec. 13, 2012

(54) RUGGEDIZED ANTENNA SYSTEM AND METHOD

(75) Inventors: John T. Armstrong, Sierra Madre, CA (US); Gregory M. Quist, Escondido, CA (US); David L. Drake, Escondido, CA (US); Aurelio L. Reyno, JR., Chino Hills, CA (US); Robert S. Hayes, Lawndale, CA (US)

(73) Assignee: HARDONEX LLC, Escondido, CA (US)

(21) Appl. No.: 13/510,591

(22) PCT Filed: Nov. 19, 2010
(86) PCT No.: PCT/US10/57489

§ 371 Date: Aug. 15, 2012

Related U.S. Application Data
(60) Provisional application No. 61/281,515, filed on Nov. 19, 2009.

(51) Int. Cl. H01Q 9/04

(52) U.S. Cl. 343/700 MS

(57) ABSTRACT

A rugged patch antenna is described that is low profile and capable of resisting environmental and physical impact. The electrical properties of the antenna do not depend on the nature of the underlying surface. The standing wave ratio, return loss and impedance of the antenna are of sufficient quality to support efficient one and two way communications. The antenna can be mounted on vehicles, aircraft, spacecraft, manhole covers, utility covers, equipment cabinets, personnel and animals.

### CROSS-REFERENCE TO RELATED APPLICATIONS

This application claims the benefit of U.S. Provisional Patent Application No. 61/281,515, filed Nov. 19, 2009, the contents of which are hereby incorporated by reference in its entirety.

### FIELD

This disclosure relates to a ruggedized antenna. More particularly this disclosure relates to broadbanding physically small antennas suitable for use in harsh environments.

### BACKGROUND

Telemetry networks are deployed to remotely monitor and control critical parameters in environmental, operational, security, energy management, industrial, military and risk management systems, to name a few, from widely dispersed locations. Other uses can be, for example, for law enforcement, commercial business transactions, medical data gathering, regulatory monitoring, real time billing, aircraft operations, transportation management, asset management, shipping, inventory, logistics, and personnel deployment.

In order to support widely distributed radio telemetry networks in real world environments, a rugged, versatile antenna is often required. In many such applications, installation space is very limited, electric power may come from batteries, solar panels or other low energy sources, and the antenna can be exposed to a wide range of risks. Unfortunately, creating antennas that provide conformal mounting with high radio signal efficiency, and are capable of withstanding multiple impacts is challenging.

Therefore, there has been long standing need for a simplified ruggedized antenna suitable for various telemetry systems in the antenna community. In view of the above, a new ruggedized antenna capable of addressing these and other demands in the community is described.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one aspect of the present disclosure, a low profile, low loss, multi-patch antenna having a center frequency and bandwidth is provided, comprising: aground plane; a first quarter wave patch disposed above the ground plane and grounded at one end; a second quarter wave patch disposed above the ground plane and grounded at one end, and displaced coplanar to and approximately one eighth wave from the first quarter wave patch; a dielectric medium between the patches and the ground plane; and an asymmetrical feed line disposed above the ground plane and having a first feed branch and a second feed branch, the first feed branch feeding the first quarter wave patch and the second feed branch feeding the second quarter wave patch, wherein a lateral length of the first and second feed branches differ by a approximately N*wavelength+one-eighth wavelength, where N is an integer.

In another aspect of the present disclosure, a method of radiating/capturing electromagnetic energy using a low profile, low loss, multi-patch antenna having a center frequency and bandwidth is provided, comprising; fabricating a first quarter wave patch above a truncated ground plane and grounding the first quarter wave patch at one end; fabricating a second quarter wave patch above the ground plane and grounding the second quarter wave patch at one end, wherein the second quarter wave patch is displaced coplanar to and approximately one eighth wave from the first quarter wave patch; fabricating an asymmetrical feed line above the ground plane with a first feed branch and a second feed branch, the first feed branch feeding the first quarter wave patch and the second feed branch feeding the second quarter wave patch, wherein a lateral length of the first and second feed branches differ by a approximately N*wavelength+one-eighth wavelength, where N is an integer.

In yet another aspect of the present disclosure, a low profile, low loss, multi-patch antenna having a center frequency is provided, comprising: first means for radiating/capturing electromagnetic energy above a truncated ground plane; means for grounding the first means for radiating/capturing electromagnetic energy at one end; second means for radiating/capturing electromagnetic energy above the ground plane; means for grounding the second means for radiating/capturing electromagnetic energy at one end, wherein the second means for radiating/capturing electromagnetic energy is displaced coplanar to and approximately one eighth wave from the first means for radiating/capturing electromagnetic energy; means for feeding/receiving electromagnetic energy to the first and second means for radiating/capturing electromagnetic energy, having a first feed branch and a second feed branch, the first feed branch feeding the first means for radiating/capturing electromagnetic energy and the second feed branch feeding the second means for radiating/capturing electromagnetic energy, wherein a lateral length of the first and second feed branches differ by a approximately N*wavelength+one-eighth wavelength, where N is an integer.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings. As such, other aspects of the disclosure are found throughout the specification.

### BRIEF DESCRIPTION OF THE DRAWINGS

FIG. 1 is an illustration of a perspective view of an exemplary antenna structure.

FIG. 2 is an illustration of a side view an exemplary antenna structure.

FIG. 3 is an illustration of a top view of an exemplary antenna structure.

FIG. 4 is a top view diagram showing dimensions of a fabricated exemplary two patch antenna

FIG. 5 is a top view diagram illustrating an arrayed exemplary antenna.

FIG. 6 is a log magnitude Smith Chart plot with a superimposed magnitude plot showing measured data for an exemplary “uncoated” two patch antenna.

FIG. 7 is a log magnitude Smith Chart plot with a superimposed magnitude plot showing measured data for an arrayed antenna

FIG. 8 is an illustration of a cross-sectional view of an exemplary antenna in a sewer system.

FIG. 9 is an illustration of a top view of an exemplary antenna structure mounted on a manhole cover.

### DETAILED DESCRIPTION

Antennas for remote applications often require the antenna's location to be limited to a conformal space near a surface. For example, the antenna may be placed in the skin of an aircraft or the top of a manhole cover. In the case of the aircraft, it is desirable that the antenna not create substantial air resistance. In the case of the manhole cover, the antenna must be mechanically able to withstand millions of vehicular impacts without significant damage as well as weather related stress such as temperature extremes, precipitation, or snowplows. Also for remote applications, antenna radiation efficiency and pattern coverage is a concern. These antennas are often referred to as low-profile antennas, having a conforming shape that is in many instances less than 1/10^{th} wavelengths in height, the actual height also depending on the mode of radiation and directivity.

A remotely operated ruggedized antenna having properties that can address the demands of conformal mounting, impact resistance and high radio signal efficiency is understood to possess several attributes. The first attribute is high efficiency which is needed to transmit and receive radio signals in a noisy radio environment. This is due to the low power requirements for many remote systems as well as the many active radio signals found in urban environments. One aspect of high efficiency can be achieved by having low losses, a typical measurement of low loss being a Voltage Standing Wave Ratio (VSWR) of less than 2. In rural environments, the radio signal must often be propagated over longer distances which can cause high signal path losses, therefore the link budget can be compensated with a high efficiency antenna.

The second attribute is the ability of the antenna to resist damage from the environment. For example, an antenna mounted on the top of a manhole cover or utility hatch may be subjected to millions of impacts from traffic and road debris. In the same vein, such an antenna may also be mounted on the exterior of an equipment cabinet and be subjected to extreme weather, vandalism, heat, cold, water, corrosive compounds and other harmful effects over the life of the antenna.

The third attribute is ease of installation. The antenna should be able to be mounted on electrically conducting surfaces such as aluminum, iron, steel or other metals, or should be able to be mounted on dielectric surfaces such as composite materials, plastics, wood, glass, ice, and related materials, as well as combination of the two. In view of the above, the antenna may also be mounted close to the surface of the skin of a person or animal for data telemetry. In all cases the antenna's radio characteristics, such as standing wave ratio, impedance, or return loss should not be affected in a manner that would prevent useful operation. In addition the antenna should not require any installation tuning or, if so, any significant amount of tuning.

The fourth attribute is ease of use. The antenna should perform in a similar manner to other conventional antennas with common characteristic impedances such as, for example, 50, 75, 300 or 600 Ohms. Maintaining an impedance commonality allows the antenna to be easily implemented in existing radio systems, without any need for modification. In the same spirit, the antenna should also allow physical connection by common coaxial components such as SMA, BNC, PL259, N, or other common connectors found in radio transmission lines.

The fifth attribute is installation versatility. The antenna should have physical and operational characteristics that enable it to be deployed in terrestrial applications such as “smart city” deployments, utility monitoring, industrial, commercial or municipal environments such as traffic, water towers, sewer monitoring, enclosure monitoring, security applications, safety monitoring, law enforcement. As such, the antenna may also be deployed on moving platforms, such as aircraft, spacecraft, space landing vehicles, boats, road vehicles, personnel, and animals.

The sixth attribute is radio service versatility—an ability to interface with well established radio networks. In some cases the radio service is provided by the use of point to point radio systems such as one or two way VHF, UHF or higher frequency transceiver pairs. Such systems can be found in supervisory control and data acquisition (SCADA) systems and similar installations of limited deployment. The antenna might also be deployed to connect remote sites to an existing one or two way radio network and provided by cell phone providers, GSM, ReFlex, Mobitex, Post Office Code Standardization Advisory (POCSAG) or other radio systems. The antenna should be able to connect to network devices such as ZigBee and other architectures that allow peer to peer routing. The antenna could also be used to communicate from ground sites to airborne or space borne one and two way radio platforms such as GlobalStar®, OrbComm®, Iridium® and balloon based systems, among others.

An exemplary antenna that combines various above attributes into a single compact, patch antenna that is easy to fabricate, inexpensive, and achieves equal or superior performance to other near ground antennas, is now described. The exemplary patch antenna is typically polarized with the electric field vector normal to the surface of the antenna. If the antenna is placed Out on the ground, or on an effective ground plane (e.g., manhole cover) the electric field polarization would normally be vertical. A patch antenna can utilize different feed points, or several patches fed with phased lines to effect Right Hand Circular Polarization (RHCP), Left Hand Circular Polarization (LHCP) and linear polarization with both Horizontal and Vertical components. Small patch antennas typically present a narrow impedance bandwidth (2% to 5%).

The exemplary antenna described herein utilizes two or more quarter wavelength (¼ λ) patches/radiating elements and a feed-based phasing network to create a nearly uniform hemispherical radiation pattern. Additionally, with appropriate feed control and phasing, the exemplary antenna is capable of providing multiple polarizations including dual polarization. Another feature of the exemplary antenna arises from the specific relationship of phasing and impedance of the transmission lines used for the patches, and from the orientation of patches relative to one another. The radiating part of the exemplary antenna is be mechanically centralized between the two patches, minimizing the effect of tuning due to environmental changes. Also, the presence of ground potentials on an end of the patches permits easy mounting.

The exemplary antenna was created while researching means to simultaneously provide good performance on 901 MHz and 940 MHz bands while achieving a small outline. Since the exemplary antenna belongs to a class of antennas known as a patch antenna, it can be fabricated using standard printed wiring board assembly techniques, and may be comprised of any of available circuit board materials, including FR-4 (Glass Epoxy), Duroid®, Epsilam®, etc. The exemplary antenna may also be fabricated using meta materials—materials with artificially engineered dielectric constants or permittivity. The exemplary antenna may also be fabricated without a substrate material. Judicious use of coating materials, such as those used to isolate the exemplary antenna from environmental factors such as impact, abrasion, chemical deterioration, etc. are known to affect the net dielectric constant, however, such effects can be compensated by the feed network as described below.

Though patches may come in ½ and ¼ λ sizes, size constraints leads to the exemplary antenna utilizing ¼ λ patches. Some aspects of ½ λ patches are that, via symmetry, the electrical potential in the center of a ½ λ patch is zero at resonance, and a short to ground can be installed at that point. The radiating element on either side of the short will not notice if the other element is removed, apart for some coupling terms that arise in the near field solutions. A similar solution can be achieved by using ¼ λ patches with one “end” of the patches shorted to ground, as further detailed below.

Another feature of the exemplary antenna is that it uses at least two patches/resonating elements which are themselves deliberately coupled and fed in common, such that the load presented by one is strongly affected by the other. These coupled resonators provide a bandpass response, in the same way a pair of lumped element resonant circuits may be coupled to form a bandpass filter, with a wider impedance bandwidth than either resonator.

In filter design, coupling between resonators is typically one of 4 types—high impedance series coupling, low impedance shunt coupling, transformer bandpass coupling, and aperture coupling. In the described exemplary embodiments, coupling between the two antenna elements or patches creates a means to impedance match the input transmission line to free space over a relatively wide bandwidth. In this way, the individual antenna elements do not require impedance broadening methodologies with their attendant losses, and the relatively high Q of the individual patch elements can be beneficial. The following illustrations demonstrate various non-limiting configurations of the exemplary antenna, whereas modifications thereto may be devised according to the knowledge of one of ordinary skill in the art.

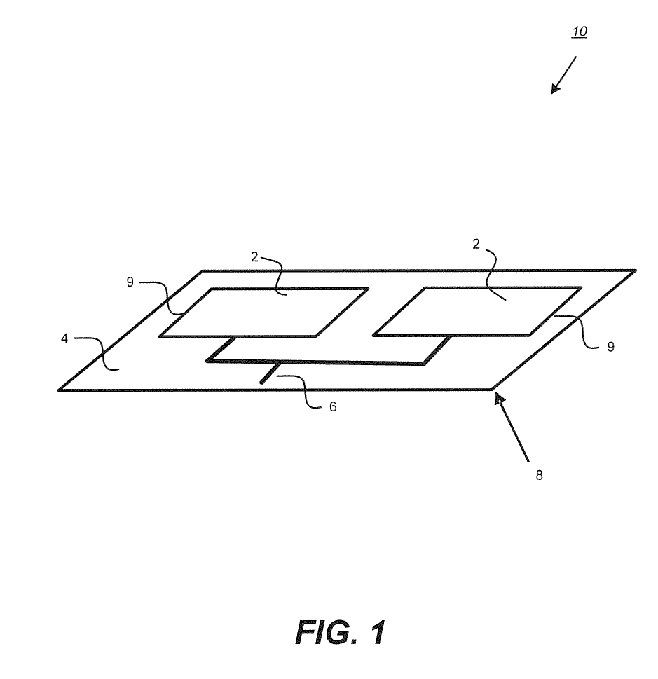

FIG. 1 is an illustration of a perspective view of an exemplary antenna structure 10 in accordance with the above description, having two ¼ λpatch elements 2 disposed above or within a dielectric (insulating) material 4. The patch elements 2 are fed via transmission line 6 that is of asymmetrical length between the patch elements 2. A ground plane 8 (not visible) is underneath the patch elements 2 being displaced from the patch elements 2 by dielectric 4. It is understood that air or vacuum can operate as the dielectric 4, therefore the patch elements 2 can be suspended above the ground plane 8. The ground plane 8 is connected to the outside edge 9 of the patch elements to short the outside edge to ground. The inner edges of patch elements 2 are displaced from each other by approximately ⅛ λ.

It should be appreciated that while the patch elements 2 in the exemplary antenna 10 shown above and in the following FIGS. are generally uniform in shape, other shapes, non-rectangular or non-uniform may be utilized according to design preference. For example, round, elliptical, square and other shapes may be used according to design preference. Similarly, while the transmission line 6 is shown as feeding the “front” of the patch elements 2, it is understood that the patch elements 2 may be fed at different locations on their respective edges or within their interior. As one example of the latter instance, the feed line 6 may protrude from a via “under” the patch elements 2 and excite each patch element 2 from a specific interior location. Therefore, numerous design dependent locations other than the “front” edge may be used for exciting the patches 2. Also, various types of feeds may be utilized such as cavity exciters, probes, microstrips, etc. for exciting a radiator. Accordingly, it is understood that modifying the shape and/or the feed structure is within the scope and purview of one of ordinary skill in the art.

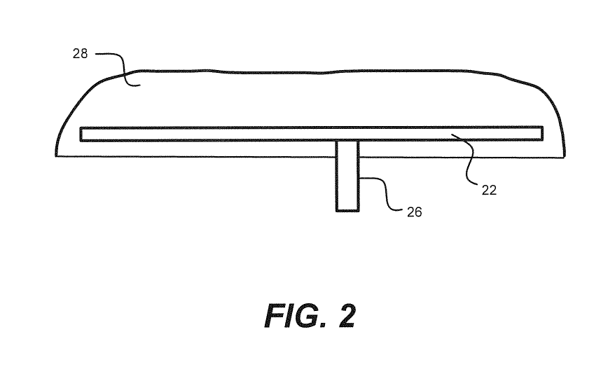

FIG. 2 is an illustration of a frontal view of an exemplary antenna 22 with an input line 26 shown offset from the antenna 22. The exemplary antenna 22 is shown coated, potted or otherwise encapsulated in a resilient material 28, such as a polymer, urethane, polytetrafluoroethylene (PTFE), ceramic or other materials to resist damage. The material 28 allows the exemplary antenna 22 to be placed in harsh environments enabling it to survive, for example, friction, rain, tires, etc. Of note here is the planar nature of the exemplary antenna 22 and its low profile.

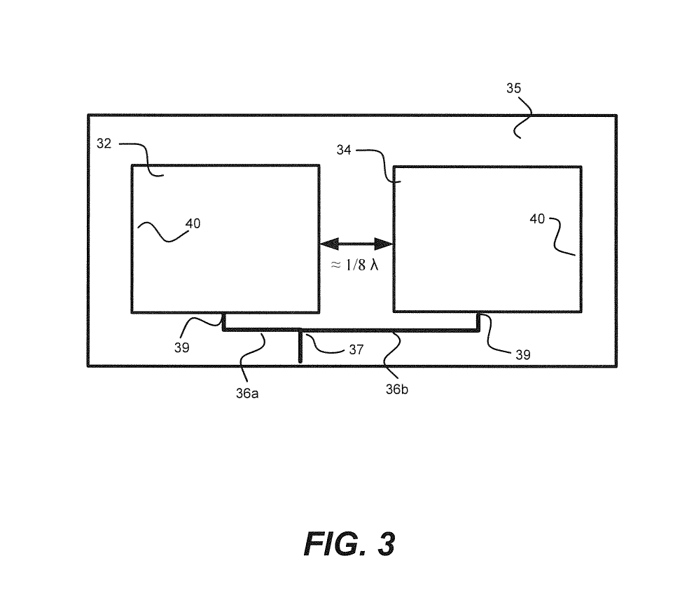

FIG. 3 is an illustration of a top view of an exemplary antenna structure supported by a substrate 35, where the patch elements 32 and 34 can be fed via 100 Ohm transmission lines 36a and 36b that are joined to form a 50 Ohm impedance point 37. The individual patch elements 32 and 34 are fed at a location 39 that presents 100 Ohms to the transmission lines 36a and 36b. A length of the 100 Ohm transmission line 36b feeding patch antenna element 34 can be 45° (λ/8) longer than the 100 Ohm transmission line 36a feeding the other patch element 32. (It is noted that a λ/8 shift can also be accomplished with a line having a length of N*λ+λ/8, where N is an integer.) The patch element 34 connected to the longer transmission 36b line is tuned lower in frequency than the patch element 32 connected to the shorter 100 Ohm transmission line 36a segment, but the exemplary antenna could work just as well with the tuning reversed. As noted above, the patch elements 32 and 34 are separated from each other by approximately ⅛ λ and also grounded approximately at the outer edge 40.

It is understood by one of ordinary skill in the antenna arts that while the above description casts the impedance in terms of a 100 Ohm transmission line, other impedances may be used as desired without departing from the spirit and scope herein.

With respect to the exemplary feeding arrangement(s) shown, feeding the patch elements 32 and 34 at 45° (λ/8) offset, due to the asymmetrical transmission line lengths, has the benefit of removing the directionality found in a typical half wave patch antenna. In a half wave patch antenna, the radiating vertically polarized sections are ½ λ apart and out of phase, meaning that they constructively add in the direction along the major axis of the patches and cancel perpendicular (lateral) to the patches. The electrical displacement along the patches is visible in the far field, and therefore the antenna appears to be horizontally polarized for a far field perspective perpendicular to the major axis of the patches. This effectively creates an omnidirectional radiation pattern.

This same radiation pattern can be obtained per the ¼ λ embodiment shown in FIG. 3, for example, with the shorted patch elements 32 and 34 offset fed at 45° (λ/8), except that the active radiating surfaces are positioned closer together than ½ λ (approximately ⅛ λ) and therefore are easier to isolate from the near field environment. A similar radiation pattern is available at other phase separations, 90° (e.g., ¼ λ) for example, but the concurrent loading which results in the broadband impedance match may not be as prominent. At 90° separation, the elements would be electrically isolated at their respective feedpoints (e.g., 39 in FIG. 3). Therefore, based on design preferences, other phase separations and feedpoint positioning may be utilized.

Based on the above, exemplary embodiments have been fabricated and shown to typically offer better than 10 dB return loss from 890 to 950 MHz and, when “arrayed,” better than 20 dB return loss simultaneously at 901 MHz and 940 MHz, making it ideal for the ReFlex pager system, as well as for the 902 to 928 MHz ISM band. Recognizing the broadband capabilities of this patch antenna design technique, the exemplary embodiments can be scaled for deployment at any other frequency range.

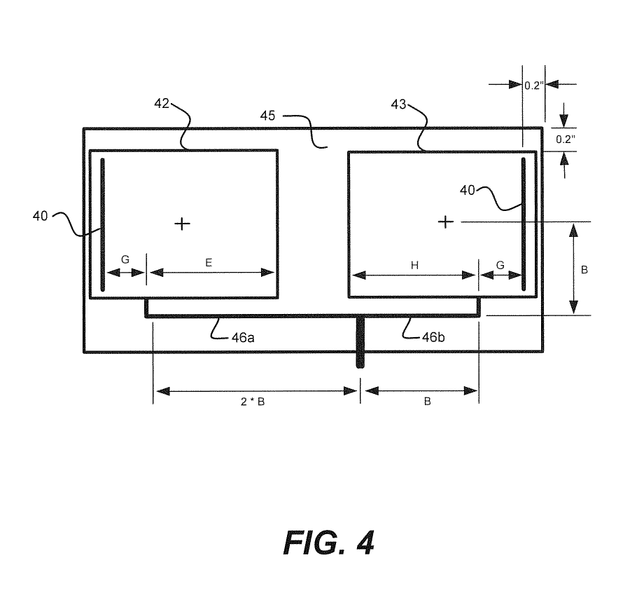

FIG. 4 is a top view diagram showing dimensions of a fabricated exemplary two patch antenna designed for operation at a center frequency of approximately 920 MHz having a patch width of approximately 1.43 inches and height of 0.06 inches, on a board/substrate 45 that is approximately 4.72 inches wide and approximately 2.05 inches high. In operation, the patch antenna of FIG. 4 is covered with a polyurethane cover, however, for the purposes of this explanation, the polyurethane covering is not shown. Vias (or ground fins) 40 are illustrated as displaced from the patch ends, and the lateral feed lines 46a and 46b are opposite of those shown in FIG. 3. Patch 42 has a width dimension (from via 40) of G+E versus patch 43's width dimension (from via 40) of H+G. Accordingly, with the dimensions provided below, patch 42 is designed to independently operate with a center frequency of approximately 901 MHz, while patch 43 is designed to independently operate with a center frequency of approximately 940 MHz. However, the center frequency of the entire patch antenna (when tested with a dielectric covering) was found to be approximately 920 MHz. The use of different center frequencies for each patch (42 and 43) provided a mechanism to perform minor tuning adjustments to achieve a reasonable input impedance and bandwidth for the aggregate antenna. Depending on tuning requirements, and also fabrication precision and feed line dimensioning, patches having similar center frequencies may be designed instead.

It should be understood that many if not all of the dimensions described herein are frequency dependent and, therefore, modifications and adjustments may be made to the exemplary embodiments without departing from the spirit and scope herein. For example, depending on fabrication tolerances, adjustments, of up to 1/20 λ or in some extreme cases 1/10 λ, to the dimensions may be made. Accordingly, the term “approximately” can be understood to encompass reasonable size variations.

The dimensions for the antenna of FIG. 4 are as follows: B≈0.92 inches, E≈0.76 inches, G≈0.78 inches, and H≈0.71 inches. When looking at patch 43, it is interesting to note that length B for lateral feed line 46b is similar to the vertical distance from lateral feed line 46b to the center (indicated by “+”) of patch 43. As noted above, these dimensions reflect an antenna designed for a specific frequency range. For other frequency ranges, the dimensions will change and such modifications are understood to be fully within the purview of one of ordinary skill in the art.

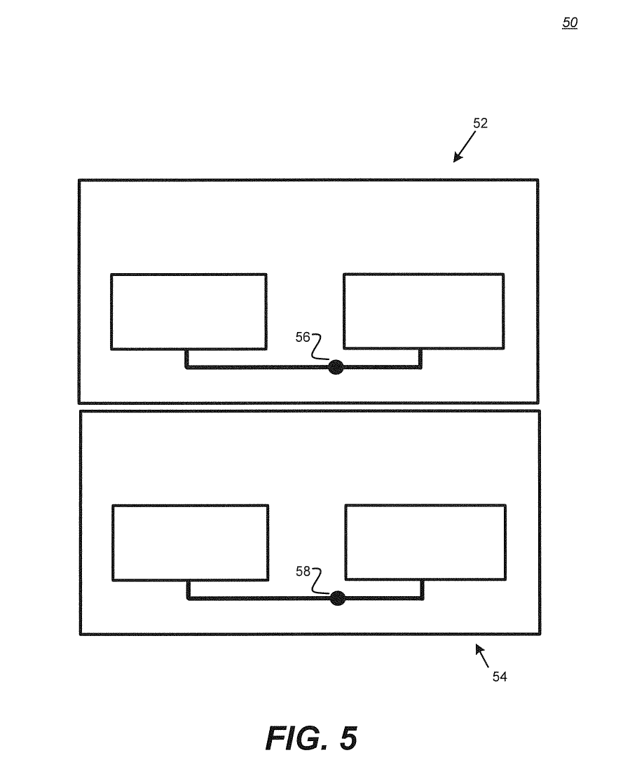

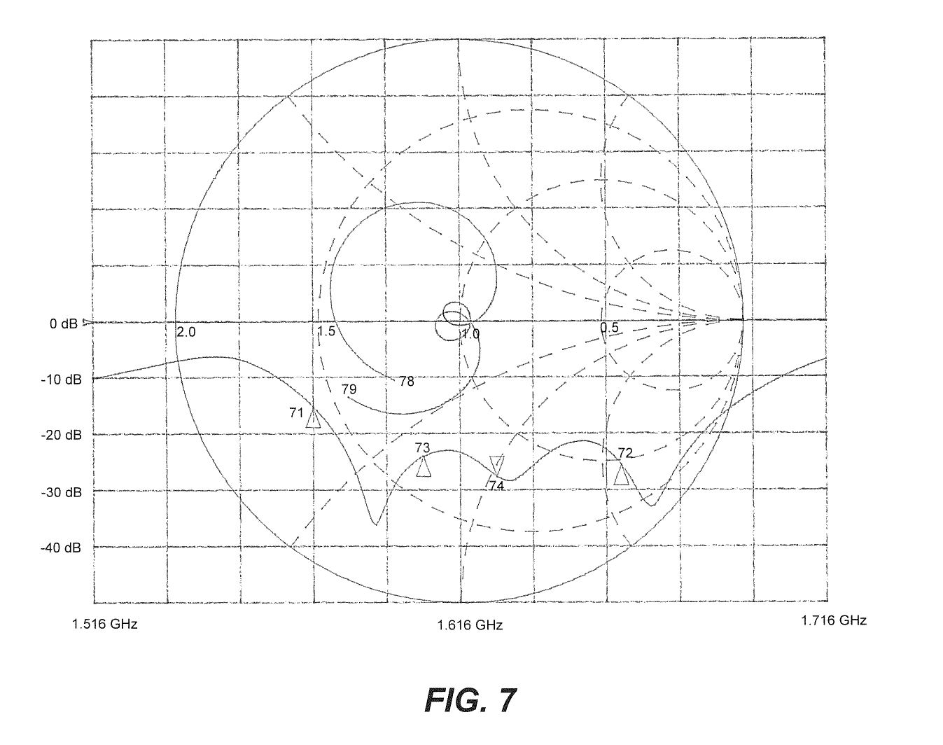

FIG. 5 is atop view diagram illustrating an arrayed exemplary patch antenna 50 with both antennas 52 and 54 driven simultaneously at feeds 56 and 58, respectively. Due to their close proximity to each other, coupling considerations come into play and this arrayed antenna 50 provides a different performance profile, as detailed below in FIG. 7.

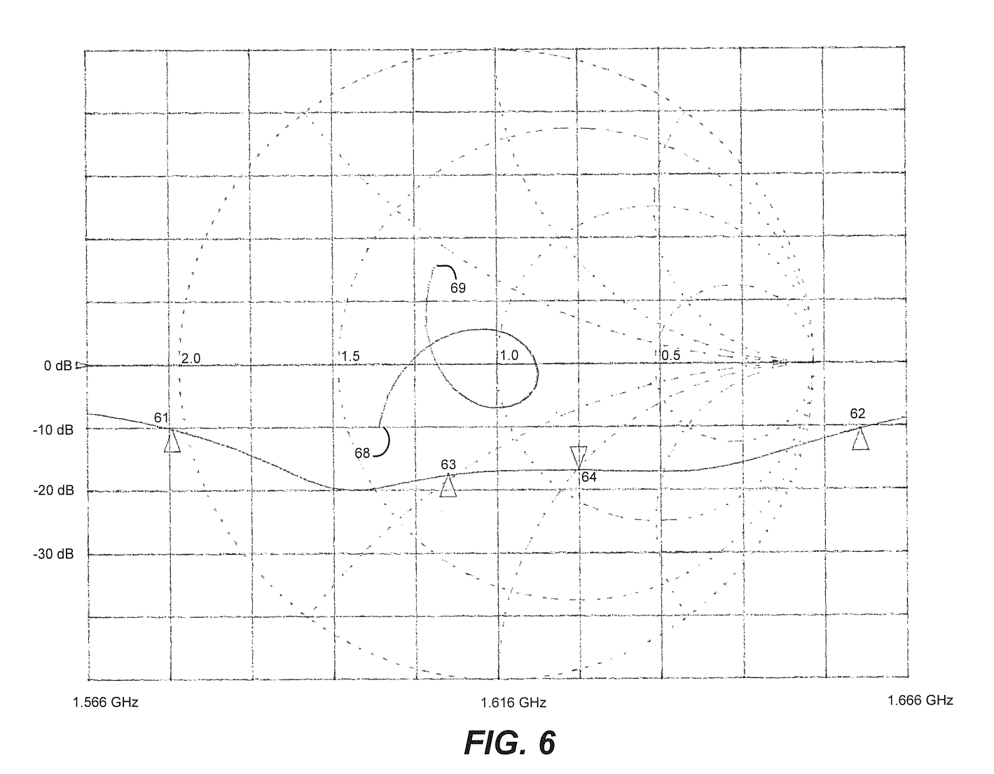

FIG. 6 is a log magnitude Smith Chart plot with a superimposed magnitude plot, normalized to a mean impedance of 50 Ohms, showing measured data for an exemplary “uncoated” two patch antenna having dimensions sized for operation at a center frequency of 1.616 GHz. On the Smith Chart, the plot of the input reflection coefficient (S₁₁) is shown with start frequency 1.566 GHz represented by 68 and stop frequency 1.666 GHz represented by 69. On the magnitude plot, frequencies 1.576, 1.660, 1.610, and 1.626 GHz correspond to frequency markers 61, 62, 63, and 64, respectively. Looking at the magnitude plot only, FIG. 6 demonstrates that the input reflection coefficient (S₁₁) magnitude is generally less than −10 dB over the tested frequency range.

FIG. 7 is a log magnitude Smith Chart plot with a superimposed magnitude plot, normalized to a mean impedance of 50 Ohms, showing measured data for the antenna of FIG. 6, however arrayed in the fashion shown in FIG. 5. On the Smith Chart, the plot of the input reflection coefficient (S₁₁) is shown with start frequency frequency 1.516 GHz represented by 78 and stop frequency 1.716 GHz represented by 79. Frequencies 1.576, 1.660, 1.610, and 1.626 GHz correspond to frequency markers 71, 72, 73, and 74, respectively. FIG. 7 demonstrates that the overall S ₁₁ magnitude is less than −20 dB over the mid-range of the tested frequencies.

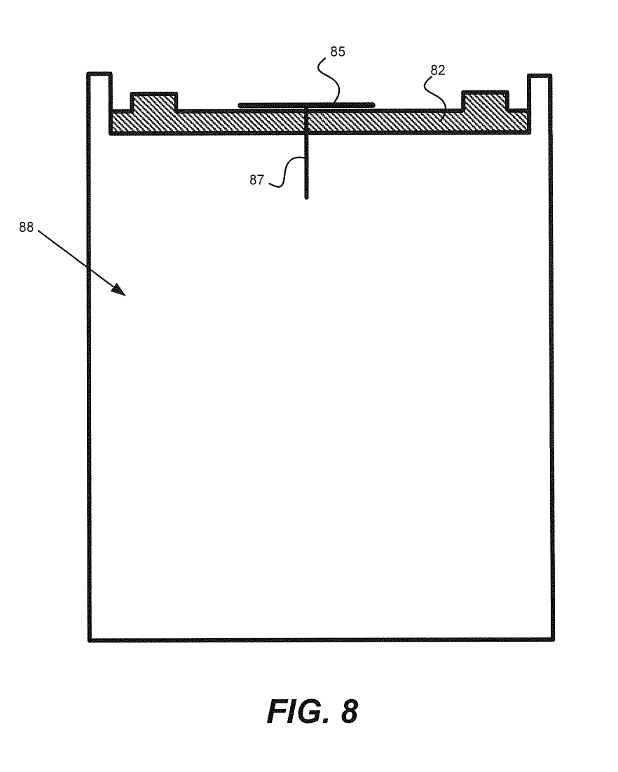

FIG. 8 is an illustration of a cross-sectional view of an exemplary antenna 85 in a sewer system. The exemplary antenna 85 is shown with a coaxial feed 87 connecting the exemplary antenna 85 to a transmitting and/or receiving device (not shown). The manhole cover 82 is shown mounted to the entrance of a sewer chamber or man hole 88. Evident from FIG. 8 is the fact that the exemplary antenna 85 has a very low profile and can be affixed to the manhole cover 82 with very little modification or interference to the overall shape of the manhole cover 82. The low profile nature of this exemplary antenna 85 makes it well suited for use with sewer or manhole monitoring systems, or systems requiring a low profile antenna.

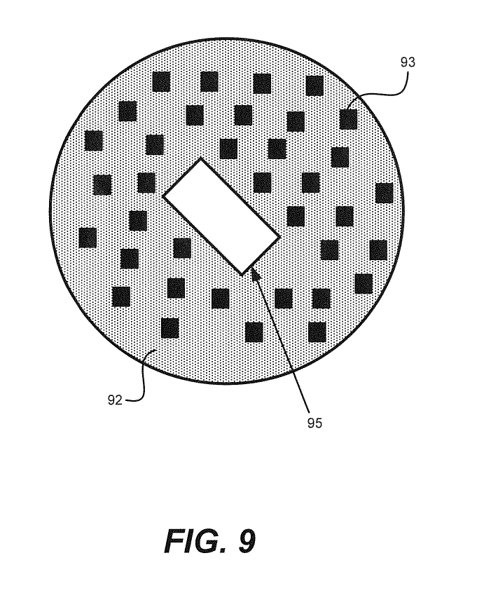

FIG. 9 is an illustration of a top view of an exemplary antenna 95 mounted on a manhole cover 92. Skid reducing elements 93 are disposed about the top surface of the manhole cover 92. This FIG. illustrates the small amount of area that is occupied by the exemplary antenna 95. As stated before, the small profile and size of the exemplary antenna 95 enables the exemplary antenna 95 to be placed in numerous other environments, for example, in or on the wing of an aircraft. Thus, while the exemplary embodiments are shown being implemented on a manhole cover, other “platforms” may be utilized without departing from the spirit and scope herein.

Consequently, the exemplary antenna provides a means to create a physically compact antenna structure that is easily isolated from its immediate physical environment and at the same time provides a means for providing broad impedance bandwidth without lossy elements. The disclosed exemplary antenna permits use of a single carrier or multiple carrier frequency, wherein the exemplary antenna can lie flat or in a conformal fashion. The conformal surface can be metallic or dielectric and the exemplary antenna provides electrically useful return loss performance, independent of mounting surface type, while providing resistance to abrasion, and other physical damage, such as that from vandalism, traffic impacts, high speed air flow, temperature excursions, weather and vacuum.

Consequently, the exemplary antenna can be used in high traffic and damage zones as that found on streets, utility covers, manhole covers, exposed enclosures, and such an antenna will adequately resist damage for an economically useful life span. The exemplary antenna can be attached to vehicles, in a manner flat or conformal to the surface that will resist damage due to abrasion and other physical damage, such as that from vandalism, traffic impacts, high speed air flow, temperature excursions, weather and vacuum.

As with all antenna structures, the exemplary antenna can provide one-way or two-way communication, when suitably coupled with a transmitter and/or transceiver. Accordingly, terrestrial, airborne and space based communication can be achieved. Additionally, mutual coupling factors can be considered in the context of a plurality of patch antennas. For example, placing two (or more) similarly designed antennas in proximity, appropriately connected, can lead to further improvement of bandwidth and efficiency. In some instances, passive ‘patches’ that are coupled by distance but not otherwise driven, have been shown to improve the return loss (VSWR) over larger bandwidths.

When fabricated with an internal ground plane the exemplary antenna can be attached via adhesives, magnets, welding, and so forth to metallic or non-metallic surfaces. Water entrapment in the exemplary antenna can be avoided by providing a protection (covering) on the antenna.

The exemplary antenna, when configured with appropriate secondary systems can be used as a radar system for altitude measurement, ranging, synthetic aperture radar, inverse synthetic aperture radar, interferometric synthetic aperture radar, radio imaging, magnetic resonance imaging, and related passive and active radar applications. As noted above, due to the small form factor and advantageous characteristics, the exemplary antenna can be “worn” on clothing or the skin and in some instances implanted into the body. In such instances, the exemplary antenna can be used as a means for tracking, if so desired. In view of the provided disclosure, numerous other applications may be contemplated by one of ordinary skill in the art.

It will be understood that many additional changes in the details, materials, steps and arrangement of parts, which have been herein described and illustrated to explain the nature of the invention, may be made by those skilled in the art within the principle and scope of the invention as expressed in the appended claims.

What is claimed is:

1. A low profile, low loss, multi-patch antenna having a center frequency and bandwidth, comprising:
a ground plane;
a first quarter wave patch disposed above the ground plane and grounded at one end;
a second quarter wave patch disposed above the ground plane and grounded at one end, and coplanar to the first quarter wave patch, radiating portions thereof being displaced from each other at a distance of approximately one-eighth wavelength;
a dielectric medium between the patches and the ground plane; and
an asymmetrical feed line disposed above the ground plane and having a first feed branch and a second feed branch, the first feed branch feeding the first quarter wave patch and the second feed branch feeding the second quarter wave patch, wherein a lateral length of the first and second feed branches differ by a approximately N*wavelength+one-eighth wavelength, where N is an integer.

2. The antenna of claim 1, wherein the antenna is covered with a protective, impact-resistant dielectric coating.

3. The antenna of claim 1, wherein the dielectric covering is conformal to another surface.

4. The antenna of claim 1, wherein a distance from the grounded end and feed point of the first quarter wave patch is approximately equal to a distance from the grounded end and feed point of the second quarter wave patch.

5. The antenna of claim 1, wherein the grounded end of the patches is grounded using vias.

6. The antenna of claim 1, wherein the ground plane is rectangular and the patches are rectangular.

7. The antenna of claim 1, wherein a perpendicular distance from a center point of the patches to the feed branches is approximately equal to the lateral length of one of the branches.

8. The antenna of claim 1, wherein the first quarter wave patch has a center frequency that is different than the second quarter wave patch.

9. The antenna of claim 1 further comprising, copies of said antenna disposed substantially adjacent and in a same plane of said antenna, to form two or more multi-patch antenna arrays.

10. The antenna of claim 1, further comprising a manhole cover, wherein the antenna is disposed on a top side of the manhole cover.

11. A method of radiating/capturing electromagnetic energy using a low profile, low loss, multi-patch antenna structure having a center frequency and bandwidth, comprising;
fabricating a first quarter wave patch above a truncated ground plane and grounding the first quarter wave patch at one end;
fabricating a second quarter wave patch above the ground plane and grounding the second quarter wave patch at one end, wherein the second quarter wave patch is displaced coplanar to and approximately one eighth wave from the first quarter wave patch; and
fabricating an asymmetrical feed line above the ground plane with a first feed branch and a second feed branch, the first feed branch feeding the first quarter wave patch and the second feed branch feeding the second quarter wave patch,
wherein a lateral length of the first and second feed branches differ by a approximately N*wavelength+one-eighth wavelength, where N is an integer.

12. The method of claim 11, further comprising covering the antenna with a protective, impact-resistant dielectric coating.

13. The method of claim 11, wherein the fabricated asymmetrical feed line is positioned so that a distance from the grounded end and feed point of the first quarter wave patch is approximately equal to a distance from the grounded end and feed point of the second quarter wave patch.

14. The method of claim 11, wherein the grounded end of the patches is grounded using vias or by metalizing the board edges.

15. The method of claim 11, wherein the fabricated asymmetrical feed line is positioned so that a perpendicular distance from a center point of the patches to the feed branches is approximately equal to the lateral length of one of the feed branches.

16. The method of claim 11, wherein the fabricated patches are fabricated with different dimensions so that the first and second quarter wave patches have different center frequencies.

17. The method of claim 11, further comprising, fabricating copies of said antenna substantially adjacent and in a same plane of said antenna, to form two or more multi-patch antenna arrays.

18. The method of claim 17, further comprising driving the feed lines simultaneously.

19. The method of claim 11, further comprising attaching the antenna to a top side of a manhole cover.

20. A low profile, low loss, multi-patch antenna having a center frequency and bandwidth, comprising:
first means for radiating/capturing electromagnetic energy above a truncated ground plane;
means for grounding the first means for radiating/capturing electromagnetic energy at one end;
second means for radiating/capturing electromagnetic energy above the ground plane;
means for grounding the second means for radiating/capturing electromagnetic energy at one end, wherein the second means for radiating/capturing electromagnetic energy is displaced coplanar to and approximately one eighth wave from the first means for radiating/capturing electromagnetic energy; and
means for feeding/receiving electromagnetic energy to the first and second means for radiating/capturing electromagnetic energy, having a first feed branch and a second feed branch, the first feed branch feeding the first means for radiating/capturing electromagnetic energy and the second feed branch feeding the second means for radiating/capturing electromagnetic energy,
wherein a lateral length of the first and second feed branches differ by a approximately N*wavelength+one-eighth wavelength, where N is an integer.
